(19) United States
(12) Patent Application Publication
(10) Pub. No.: US 2010/0071787 A1
(43) Pub. Date: Mar. 25, 2010

(54) SYSTEM, INCLUDING A VARIABLE ORIFICE ASSEMBLY, FOR HYDRAULICALLY MANAGING PRESSURE IN A FLUID DISTRIBUTION SYSTEM BETWEEN PRESSURE SET POINTS

(75) Inventors: Robert Folk, Laguna Beach, CA (US); Daniel Ré, Les Agettes (Valais) (CH)

Correspondence Address: KELLY LOWRY & KELLEY, LLP, 6320 CANOGA AVENUE, SUITE 1650, WOODLAND HILLS, CA, 91367, US

(73) Assignee: CLA-VAL CO., Costa Mesa, CA (US)

(21) Appl. No.: 12/625,011

(22) Filed: Nov. 24, 2009

Related U.S. Application Data
(63) Continuation-in-part of application No. 12/062,946, filed on Apr. 4, 2008.
Application No. 12/062,946 is a continuation-in-part of application No. 11/927,474, filed on Oct. 29, 2007.
(60) Provisional application No. 61/118,376, filed on Nov. 26, 2008.

(51) Int. Cl. G05D 16/16; F16K 31/12

(52) U.S. Cl. 137/489; 137/625.61

(57) ABSTRACT

A system for hydraulically managing fluid pressure in a fluid distribution system between pressure set points includes a main valve having a fluid inlet and outlet. The main valve is configured to open to increase fluid flow therethrough and to close to reduce the fluid flow therethrough. A variable orifice assembly is coupled to the main valve and has fluid apertures formed in a housing thereof to create a fluid flow pathway therebetween. A valve stem is variably positioned within the housing to alter the fluid flow between the fluid apertures. A first control pilot is in fluid communication with the main valve and a first fluid aperture of the variable orifice assembly. A second control pilot is in fluid communication with the main valve and a second fluid aperture of the variable orifice assembly. The valve position and fluid flow are variable as the main valve opens and closes.

### BACKGROUND OF THE INVENTION

The present invention generally relates to automatic valves, such as those employed on municipal water utility systems. More particularly, the present invention relates to a system for hydraulically adjusting and managing pressure between set points so as to control pressure downstream of a main valve in such a fluid distribution system.

There is a general understanding throughout the worldwide water supply industry that instances of water loss are common in many water distribution networks and in many instances the level of water loss can be relatively high. The amount of water loss in the system is due to a variety of leak sources, such as improperly tightened pipe flange connections, leaking flange gaskets, leaking valve seals, failed seals, old pipes (with pinhole bursts), loose fittings, leaky faucets, etc. The sum of these sources of leakage can add up to a substantial amount of water loss. Maintaining the entry point pressure at all times at the level necessary to provide adequate pressure at the distant points for periods of high demand can result, during periods of low demand, in excessive pressure at the consumer's premises, and thus increased waste of water by unnecessary consumption and leakage. The volume of water lost through leakage is directly related to pressure in the system.

Automatic pressure reducing valves are used in water distribution systems to reduce pressure to a pre-determined value or sub-point that is adequate, but does not expose normal components, such as household hot water tanks, to overpressure. The sub-point is typically determined to provide minimum pressure that meets criteria of the water utility, particularly under maximum or “peak” demand conditions which can occur when a fire is being fought. The pressure required for peak demand is usually significantly higher than that required for “off-peak”, such as typical nighttime conditions. Under low demand conditions, not only does leakage form a higher proportion of the total demand, but investigation has implied that some leak orifices can actually increase in area with pressure, aggravating the problem if excessive pressures are maintained at all times.

Various attempts have been previously made to reduce such losses by introducing a degree of control over the supply pressure in response to demand. One known system uses electrical circuit means with pressure and flow-rate sensors from monitoring pressure and flow-rate and then processing the information obtained and using it in turn to control suitable electrically operated valve means. Such systems are, however, relatively complex and expensive and require a continuous external power supply giving rise to additional capital and running costs and reliability problems.

There also exist flow-driven valves which use fluid pressures to control actuation of the main valve, and thus are independent of external power sources and can be used in essentially any location. One such flow-driven valve system is disclosed in U.S. Pat. No. 5,967,176 to Blann, et al. The system controls high and low pressures by utilizing the pressure drop across an orifice plate that is installed in the main line, usually attached directly to the inlet or outlet flange of the main valve. The pressure control is independent of the main valve position, and is a direct function of system flow. The pressure control device monitors the pressure drop or flow across the orifice plate. Control pressure is varied based upon the movement of a pilot valve member with respect to a fixed pilot valve member, which in turn controls the main control valve.

However, this system has many shortcomings. The diameter of the orifice plate may need to be customized for different high/low flow applications. For example, a smaller orifice diameter may be required if flows are not sufficient to develop the required pressure drop across the system orifice. Likewise, the system orifice may need to be increased if pressure drops are too large because a smaller orifice can limit the flow capacity of the system. The orifice plate also decreases the capacity of the main valve. This is particularly a concern when high flow is necessary, such as a high flow of water to fight a fire or the like. The added orifice plate limits the capacity of the main valve for fire flow situations. Moreover, it is difficult to retrofit existing valves with this system as the flange spacing must be modified to accommodate the orifice plate, typically requiring removal of the main valve from the line.

Accordingly, there is a continuing need for an improved flow-driven valve system for automatically controlling downstream pressure between selected set points. The present invention fulfills these needs and provides other related advantages.

### SUMMARY OF THE INVENTION

The present invention resides in a system and method for hydraulically managing fluid pressure downstream of a main valve. As will be more fully described herein, the system is flow-driven and responds to changing flow demand downstream from a main valve, so as to manage and control the fluid pressure downstream from the main valve between predetermined set points. The system is designed to hydraulically open the main valve assembly during high demand conditions, and close the main valve during low demand conditions, resulting in a reduction of the amount of water loss in a waterworks system downstream of the main valve assembly.

The system embodying the present invention for hydraulically managing fluid pressure in a fluid distribution system between pressure set points generally comprises a main valve having a main valve body defining a fluid inlet and a fluid outlet. A main valve seat is disposed between the fluid inlet and the fluid outlet. A main valve member is movable between an open position away from the main valve seat and a closed position towards the main valve seat. A main valve diaphragm is coupled to the main valve member, the main valve diaphragm and the main valve body, or a cover thereof, defining a pressure control chamber. The main valve is configured to open to increase fluid flow therethrough, and to close to reduce fluid flow therethrough.

A variable orifice assembly is coupled to the main valve. The variable orifice assembly comprises a housing attachable to the main valve and defining an inner chamber. A plurality of fluid apertures, typically at least three apertures, are formed through the housing for coupling the inner chamber to a source of fluid. A valve stem is disposed within the inner chamber of the housing and movable generally along a length of the inner chamber in response to the main valve opening and closing. The valve stem has a non-uniform outer configuration, creating a fluid pathway thereover. In a particularly preferred embodiment, the valve stem outer configuration forms multiple variable area fluid flow passageways or slots. Fluid flow between the fluid apertures is dependent, in part, on the position of the valve stem within the inner chamber.

The variable orifice assembly also includes a sleeve which is disposed between the valve stem and an inner wall of the housing defining the inner chamber. The sleeve is selectively movable along a length of the inner chamber to vary the fluid flow between the fluid apertures of the housing. An actuator, such as a manually rotatable nut, is coupled to the housing and the sleeve for selectively moving the sleeve.

A stop plate is also disposed within the housing, between an end of the valve stem and the main valve for limiting travel of the valve stem within the housing. A second actuator, such as a second manually rotatable nut, is coupled to the housing and the stop plate for selectively moving the stop plate.

A rod is extendable through an aperture of the stop plate so as to engage the valve stem at one end thereof, and is engageable or coupled to a valve member of the main valve at a generally opposite end thereof. The valve stem is biased towards the stop plate, and moved away from the stop plate by the rod. The valve stem is variably positioned within the housing to alter the fluid flow between the fluid apertures. The valve position and the fluid flow are variable as the main valve opens and closes.

A first control pilot device is in fluid communication with the main valve and a first fluid aperture of the variable orifice assembly. A second control pilot is in fluid communication with the main valve and a second fluid aperture of the variable orifice assembly. The first control pilot device is used to set the upper pressure set point of the system, while the second control pilot device is used to set the lower pressure set point of the system. The first and second control pilot devices each include a diaphragm disposed between fluid chambers thereof. The position of the diaphragm is variable depending on the pressure differential between the chambers and a bias applied to the diaphragm. The position of the diaphragm varies the fluid flow between an inlet and outlet thereof.

The first control pilot device is fluidly coupled to the main valve pressure control chamber and directs fluid into the pressure control chamber of the main valve to close the main valve as fluid flow between fluid apertures of the variable orifice assembly coupled to the first and second control pilot devices is restricted. Fluid is allowed to flow out of the pressure control chamber of the main valve and open the main valve as fluid flow between the fluid apertures of the variable orifice assembly is less restricted. The position of the stop plate and sleeve of the variable orifice assembly, and the degree of bias of the valve stem of the variable orifice assembly can all be altered to adjust pressure gradients for the system.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a schematic illustration of a system for hydraulically managing fluid pressure downstream of a main valve between selected set points in a low fluid flow state;

FIG. 2 is a schematic illustration of the system of FIG. 1, but with the system in a high fluid flow state;

FIG. 3 is a perspective view of a variable orifice assembly used in the system of the present invention;

FIG. 4 is a cross-sectional view of the variable orifice assembly, illustrating the various component parts thereof positioned when a main valve of the assembly is in a low flow state;

FIG. 5 is another cross-sectional view of the variable orifice assembly used in the system of the present invention, illustrating the various component parts thereof in position when the main valve of the system is in a high flow state;

FIG. 6 is another cross-sectional view of the variable orifice assembly when the main valve of the system is closed and a sleeve and seat thereof are in a lower position;

FIG. 7 is another cross-sectional view of the variable orifice assembly, similar to FIG. 7, but illustrating the sleeve in a raised position;

FIG. 8 is another cross-sectional view of the variable orifice assembly with the seat in a raised position and the main valve of the system in a closed position;

FIG. 9 is another cross-sectional view of the variable orifice assembly similar to FIG. 8, but illustrating the valve stem thereof moved to an upper position due to the opening of the main valve of the system, in accordance with the present invention; and

FIGS. 10-13 are diagrammatic illustrations illustrating adjustment of the high pressure and low pressure set points of the system of the present invention.

### DETAILED DESCRIPTION OF THE PREFERRED EMBODIMENTS

As shown in the accompanying drawings, for purposes of illustration, the present invention is directed to adjustable hydraulically operated pressure management control valve systems. As will be more fully described herein, the present invention is directed to a system for hydraulically managing fluid pressure in a fluid distribution system between pressure set points so as to manage fluid pressure downstream of a main valve of the fluid distribution system. The systems of the present invention are particularly adapted for use in the waterworks industry where there is a desire to reduce the amount of water loss in the system due to leaks. The invention can reduce the amount of water loss in a system by reducing the system pressure as the flow or system demand decreases. A common example would be a residential water system where water demand is high during the day and low at night. If the pressure is lower during low usage, then a lower pressure will result in lower water losses throughout the system.

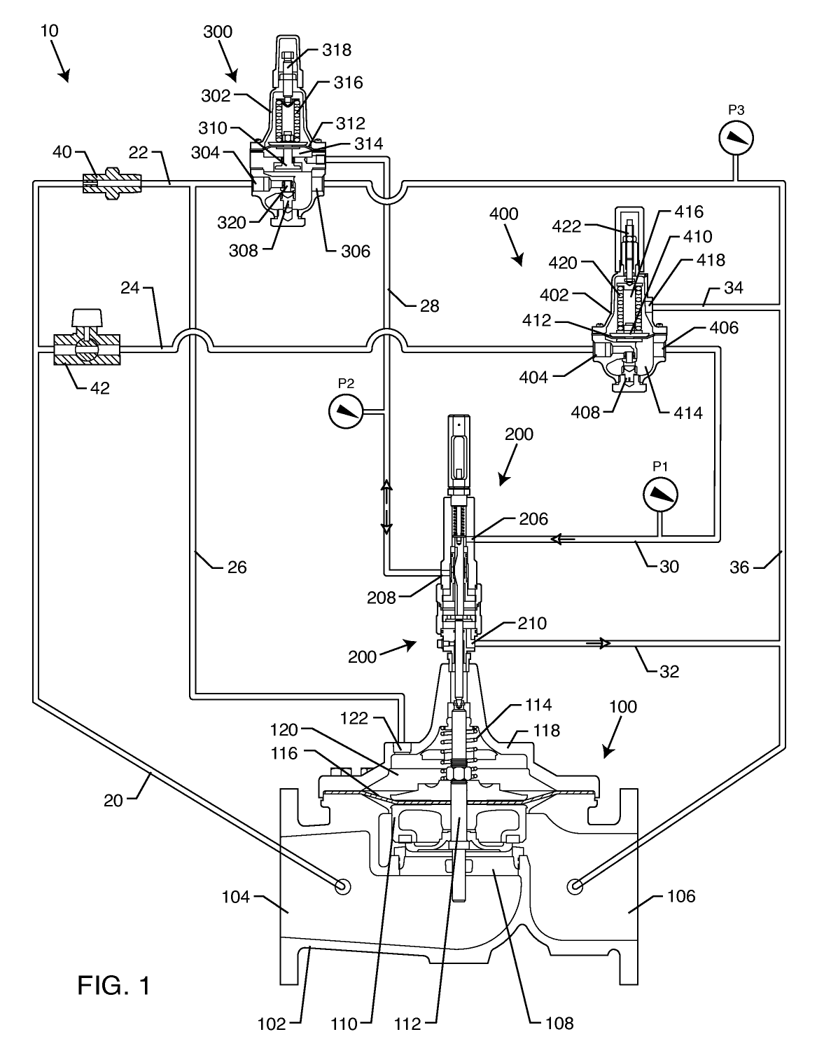

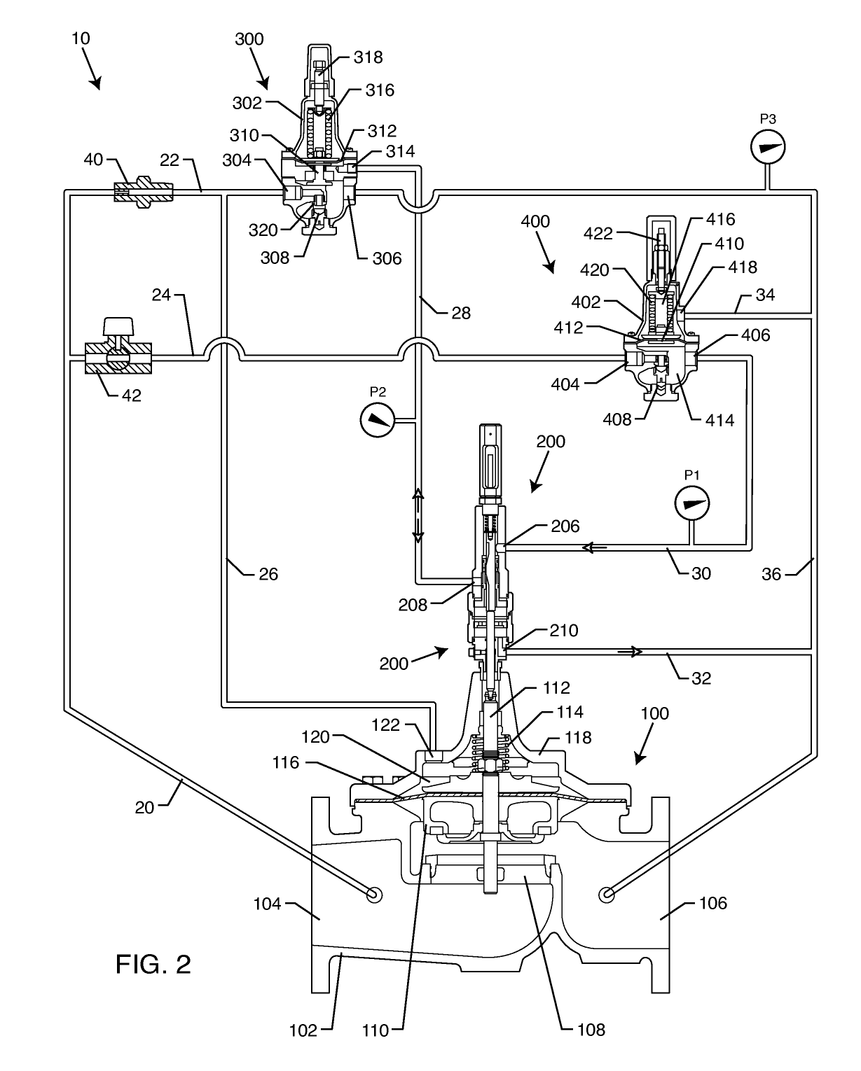

With reference now to FIGS. 1 and 2, the system 10 of the present invention comprises a main valve assembly 100 operably connected to a variable orifice assembly 200 and fluidly coupled to control pilot devices 300 and 400. Various conduits 20-36 fluidly couple these components and provide a pressurized source of fluid, as will be more fully described herein. As can be seen in FIGS. 1 and 2, a fixed orifice 40 is disposed between conduits 20 and 22, or that is between a point upstream or at the inlet of main valve 100 and control pilot device 300. A shut-off valve 42 is disposed between the main valve 100 and control pilot device 400, and more particularly, as illustrated, between conduits 20 and 24, the purpose and use of which will be more fully explained herein. It will be appreciated by those skilled in the art that the labeling of the conduits 20-36 is for ease of illustration and explanation, such conduits and piping potentially being continuous.

With reference now to FIGS. 1 and 2, the main valve 100 is comprised of a main valve body 102 defining an inlet 104 and an outlet 106. Intermediate the main valve inlet and outlet 104 and 106 is a main valve seat 108. A main valve member is movable between an open position away from the main valve seat 108, as illustrated in FIG. 2, and a closed position engaging the main valve seat 108, as illustrated in FIG. 1. The main valve member 110 includes a movable stem 112 for guiding the main valve member 110 into and out of engagement with the main valve seat 108. A spring 114 is typically also implemented in facilitating and guiding the main valve member 110 movement. A main valve diaphragm 116 is coupled to the main valve member 110 and extends between the main valve body 102 and a cover 118 of the main valve 100 so as to define a fluid control chamber 120 between the diaphragm 116 and the cover 118, or other portion of the body 102. The control chamber includes an inlet port 122 for fluid coupling with conduit 26.

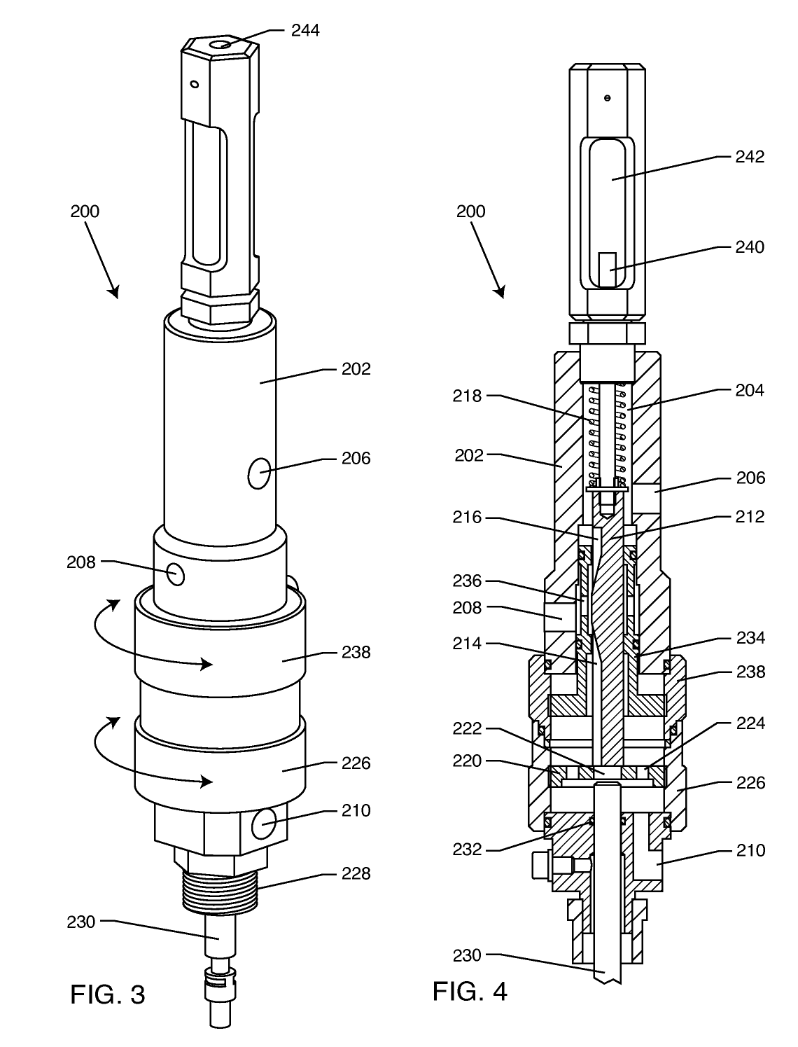

As illustrated in FIGS. 3-5, the variable orifice assembly 200 includes a housing 202 defining an inner chamber 204 and having a plurality of fluid flow apertures 206-210 formed therein so as to provide a source of external fluid into the inner chamber 204 of the housing 202. Typically, there are three fluid apertures 206-210 which are spaced apart from one another in the housing, such that the inner chamber 204 could be considered to have an upper chamber corresponding to the upper aperture 206, an intermediate chamber corresponding to the intermediate aperture 208 and a lower chamber corresponding to the lower aperture 210. However, the inner chamber 204 is substantially continuous and such upper, intermediate and lower chambers are not necessarily distinct from one another, although they may be defined by the inner wall profile of the housing 202 or other component parts therein, but are primarily used for explanatory purposes herein. As can be seen from FIGS. 1 and 2, the upper or first fluid aperture 206 is fluidly connected to an outlet of control pilot device 400, and the intermediate or second fluid aperture 208 is fluidly coupled to a control pressure chamber of control pilot device 300. The third or lower-most fluid aperture 210 is fluidly coupled to the main valve outlet 106 by means of conduits 32 and 36.

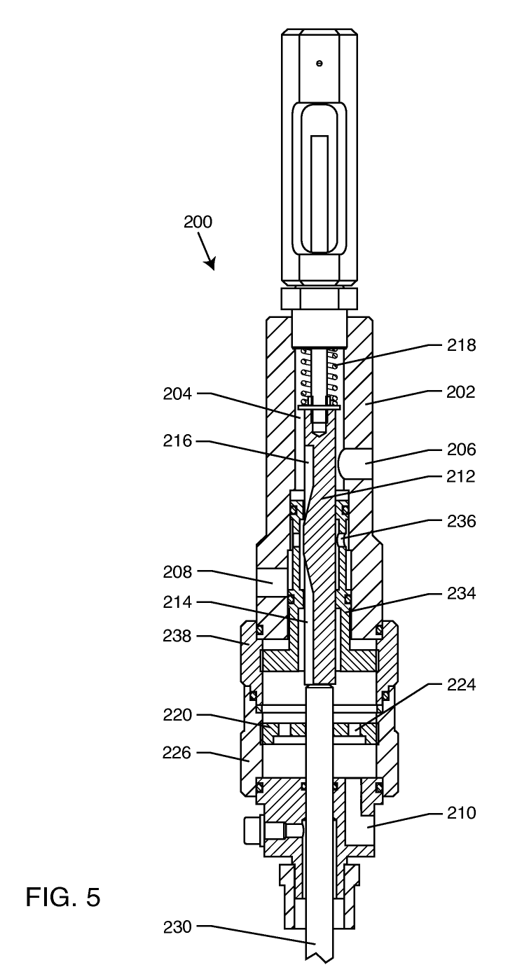

With continuing reference to FIGS. 4 and 5, a valve stem 212 is disposed within the housing 202 so as to be variably positioned within the housing 202, and more particularly the inner chamber 204 so as to alter fluid flow between the fluid apertures 206-210. As will be described more fully herein, the valve stem 212 is movable generally along a length of the inner chamber 204 in response to the main valve 100 opening and closing.

As can be seen in FIGS. 4 and 5, the valve stem 212 has a non-uniform outer configuration, which creates a fluid pathway thereover. More particularly, the valve stem outer configuration forms multiple variable area fluid flow passageways 214 and 216, sometimes referred to herein as slots.

The valve stem 212 of the variable orifice assembly 200 is biased downwardly and towards a stop plate 220 by means of a spring 218. The stop plate 220 has an aperture 222 formed therein which is typically of a smaller diameter than the diameter of the valve stem 212. One or more other apertures 224 are also formed therein so as to provide a fluid flow pathway between fluid apertures 208 and 210. The stop plate 220 can be variably positioned within the housing 202, particularly in the lower chamber area of inner chamber 204 between apertures 208 and 210. Such is done in order to limit the travel of valve stem 212. The stop plate 220 can be selectively moved by means of an actuator, typically in the form of a manually rotatable nut 226, which is rotatably coupled to the housing 202 and the stop plate 220 for selectively moving the stop plate 220 upwards or downwards depending upon the direction of rotation of the nut 226.

The variable orifice assembly 200 is typically connected to the main valve 100, by means of a threaded connection 228 to the cover 118 of the main valve 100, such that a rod 230 of the variable orifice assembly 200 is coupled to the main valve stem 112, so as to be moved as the main valve 100 is opened and closed. The aperture 222 of the stop plate 220 is of a sufficient diameter to permit the rod 230 to extend therethrough and engage the variable orifice valve stem 212 and move it upwardly or away from the stop plate 220. Although the housing 202 of the variable orifice assembly 200 is coupled to the main valve member 100, and the rod 230 allowed to move into the main valve 100 and extend into the inner chamber 204 of the variable orifice assembly 200, the fluid pressures within the inner chamber 204 of the variable orifice assembly 200 and the main valve 100 are isolated from one another. This is done, for example, by means of an O-ring 232 through which the rod 230 extends.

With continuing reference to FIGS. 4 and 5, a sleeve or guide 234 is disposed between an inner wall of the housing 202 defining the inner chamber 204 and the valve stem 212. The sleeve 234 includes apertures or slits 236 which permit fluid to pass over or around the valve stem 212 and into various portions of the inner chamber 204, depending upon the alignment of the sleeve apertures 236 and the slots 214 and 216 or passageways of the valve stem 212. Moreover, the sleeve 234 is selectively positionable and movable within the housing 202, similar to the stop plate 220. That is, an actuator 238, typically in the form of a manually rotatable nut is operably coupled to the housing 202 and the sleeve 234, such that as the nut actuator 238 is rotated the sleeve 234 is moved upwardly or downwardly within the housing 202.

With continuing reference to FIGS. 4 and 5, an upper end or extension 240, which may comprise a rod connected to an upper end of the stem valve 212, extends through spring 218 and into a window 242 such that the relative position of the valve stem 212 can be ascertained by those installing or adjusting the system 10. An air release screw 244 is used to selectively release air from within the inner chamber 204.

With reference again to FIGS. 1 and 2, the first control pilot device 300 includes a housing 302 having a fluid inlet 304 and a fluid outlet 306. A poppet 308 is carried on a stem or member 310 which can move up and down and close or open an opening between the poppet 308 and a seat 320 which forms the fluid pathway between the inlet 304 and the outlet 306.

A diaphragm 312 is attached to the stem 310 and forms a variable control pressure chamber 314. This pressure chamber 314 is fluidly connected to the intermediate or second fluid aperture 208 of the variable orifice assembly, such as by means of conduit 28. A spring 316 applies a bias to the diaphragm 312 and stem 310. The amount of bias can be controlled by means of turning screw 318 so as to compress or decompress spring 316.

It will be readily understood that when pressurized fluid is directed into the pressure chamber 314, the diaphragm 312, and thus the stem 310 will move upwardly, causing poppet 308 to move into a closed or restricted position, thus closing off the pathway between the inlet 304 and the outlet 306 of the control pilot device 300. However, when the fluid pressure in pressure chamber 314 is lowered, the bias of spring 316 causes the diaphragm 312 to move downwardly, and thus poppet 308 to move downwardly, and out of engagement with seat 320 and open the fluid passageway between the inlet 304 and the outlet 306. Adjustment of spring 316, by means of screw or actuator 318 directly impacts the upper pressure set point, or high flow set point of the system 10.

With continuing reference to FIGS. 1 and 2, the second control pilot device 400 is used to establish the low pressure set point, or a range of low pressure, so as to adjustably control a lower pressure set point for the system 10, such as during a lower flow of fluid through the main valve 100. The second control pilot device 400 also includes a housing 402 having an inlet 404 and an outlet 406. A poppet 408 is attached to a stem or member 410 which is also attached to a diaphragm 412 defining a lower fluid chamber 414 and an upper fluid chamber 416. As can be seen in FIGS. 1 and 2, the lower fluid chamber 414 is formed between the inlet 404 and outlet 406 of the control pilot device 400. The upper fluid chamber 414 has an inlet which couples conduit 34 (and conduit 36) to the upper fluid chamber 414.

Once again, a spring 420 is used to bias the position of the diaphragm 412, which can be adjustably controlled by means of a set screw 422. The set screw 422 can be turned to compress or decompress spring 420, which will impact the bias of diaphragm 412. Turning the set screw 422 adjusts the low pressure set point.

Thus, control pilot device 300 adjusts the maximum high pressure during high flow conditions, such as illustrated in FIG. 2. The second control pilot device 400 reduces the pressure to fluid inlet 206 of the variable orifice assembly 200 according to main valve outlet pressure. The control pilot device 400 adjusts the low pressure during low flow conditions, such as illustrated in FIG. 1.

With reference now to FIGS. 1 and 4, during main valve low flow situations, as illustrated in FIG. 1, the fluid flow through the upper slot or passageway 216 of the multi-slot stem 212 is unrestricted and flow through the lower slot detail or passageway 214 is proportionally restricted. This causes the pressure in the intermediate and upper portions of inner chamber 204 and the pressure in pressure chamber 314 of control pilot device 300 to increase until pressure at P2 is substantially the same as pressure at P1, representing the free flow of fluid through the inlet 404 and outlet 406 of control pilot device 400. In such a scenario, the fluid flow from conduit 20, through conduit 24, through control pilot device 400, through conduit 30, into the upper fluid aperture 206, through chamber 204, and out fluid aperture 208 and into the pressure chamber 314 of control pilot device 300 is relatively unimpeded. This causes the diaphragm 312 to move upwardly, and close the passageway between poppet 308 and seat 320, restricting the flow of fluid between inlet 304 and outlet 306 of the control pilot device 300. This creates a back pressure of fluid in conduits 22 and 26, resulting in an increase of flow into control chamber 120 of the main valve 100, the increased fluid pressure causing the diaphragm 116 to move downwardly, and the main valve member 110 to close towards seat 108.

When pressure at P1 and P2 are substantially equal, pressure reducing control pilot device 300 is regulating downstream pressure P3 at the low pressure set point. During this condition, the main valve 100 is operating at or near the closed position, as illustrated in FIG. 1.

During main valve 100 normal to high flow situations, as illustrated in FIG. 2, the upper slot or variable area passageway detail of the multi-slot stem 212 is restricted and flow through the lower slot detail 216 of the stem 212 is proportionally unrestricted. This causes pressure at P2 and the pressure in the pressure sensing chamber 314 of the control pilot device 300 to decrease. A relative decrease of pressure in these chambers causes pressure reducing pilot control device 300 to throttle towards the open position.

As the pressure downstream of main valve 100 decreases, the pressure in chamber 416 decreases, and diaphragm 412 is moved upwardly by spring 420. This closes the passageway between the inlet 404 and outlet 406 of the control pilot device 400, and the fluid pressure through conduit 30 is reduced. As the main valve 100 starts to open, the flow area through the variable area passageways or slots 214 and 216 changes. The relative change in slot flow area is such that flow area through the upper slot 216 gradually decreases while flow area through the lower slot gradually increases, as illustrated in FIG. 5. This enables a fluid flow between the second or intermediate fluid aperture 208 and the lower or third aperture 210 of the variable orifice assembly. Such fluid flow is through the lower portion or lower chamber of the inner chamber 204 through the apertures 224 of the stop plate 220. Thus, fluid is allowed to flow out of the pressure control chamber 314 of pressure control device 300, causing diaphragm 312 to be biased downwardly, thus moving poppet 308 away from seat 320 and opening the passageway between the inlet 304 and outlet 306 of the control pilot apparatus 300. This enables the main valve member 110 to move upwardly and push fluid out of the control chamber 120.

As pressure P1 becomes greater than P2, pressure reducing control pilot device 300 responds by regulating downstream pressure P3 towards the higher pressure set point, as illustrated in FIG. 2. When pressure at P1 is significantly greater than P2, pressure reducing control pilot device 300 is regulating at or near the high pressure set point. During higher flow demand conditions, the main valve 100 is operating at open positions sufficient to meet system flow demand at the higher pressure set point, as illustrated in FIG. 2.

As the main valve 100 opens, the stem 212 of the variable orifice assembly 200 likewise travels, causing the flow area through the variable area passageways 214 and 216 to change, as described above, as the main valve 100 continues to open.

The shape of each slot, or variable area fluid flow passageways 214 and 216 can be customized to achieve a desired pressure regulation profile between low and high pressure set points. The transition between low and high pressure is a function of the slot 214 and 216 profiles and the adjusted position of the sleeve or stem guide 234 and the stop plate 220.

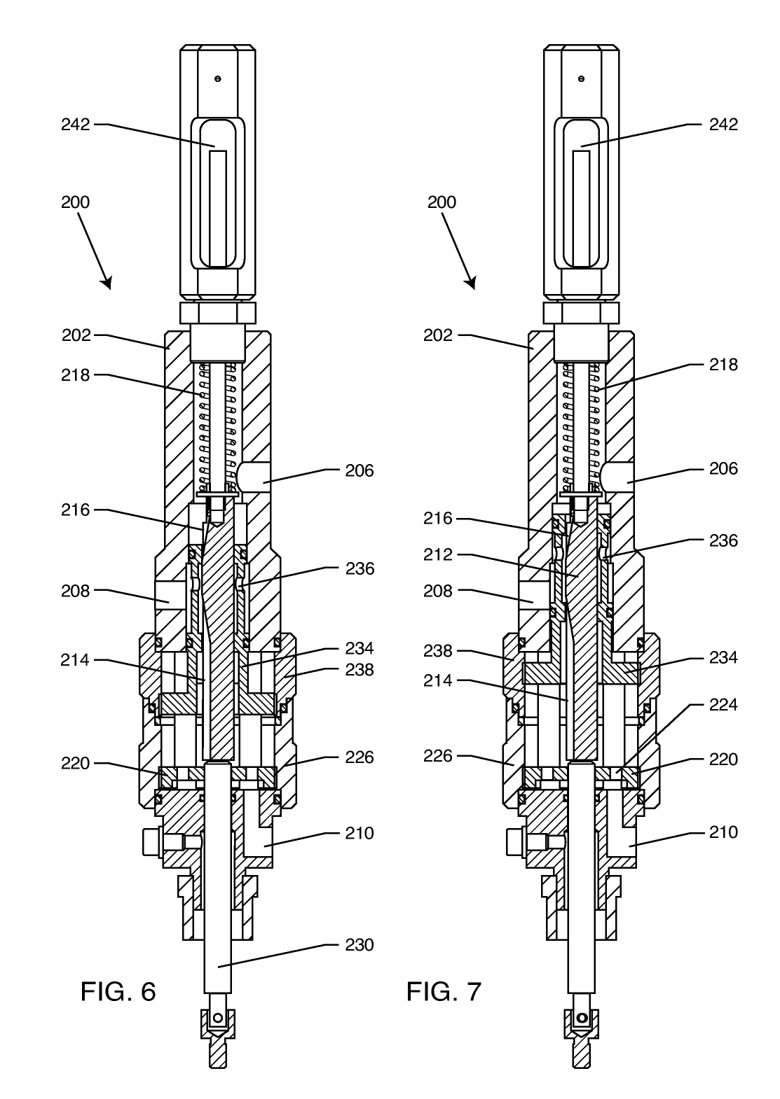

With reference now to FIG. 6, a cross-section of the variable orifice assembly is shown when the main valve 100 is substantially closed. The sleeve 234 and the stop plate 220 are shown moved to a lower position.

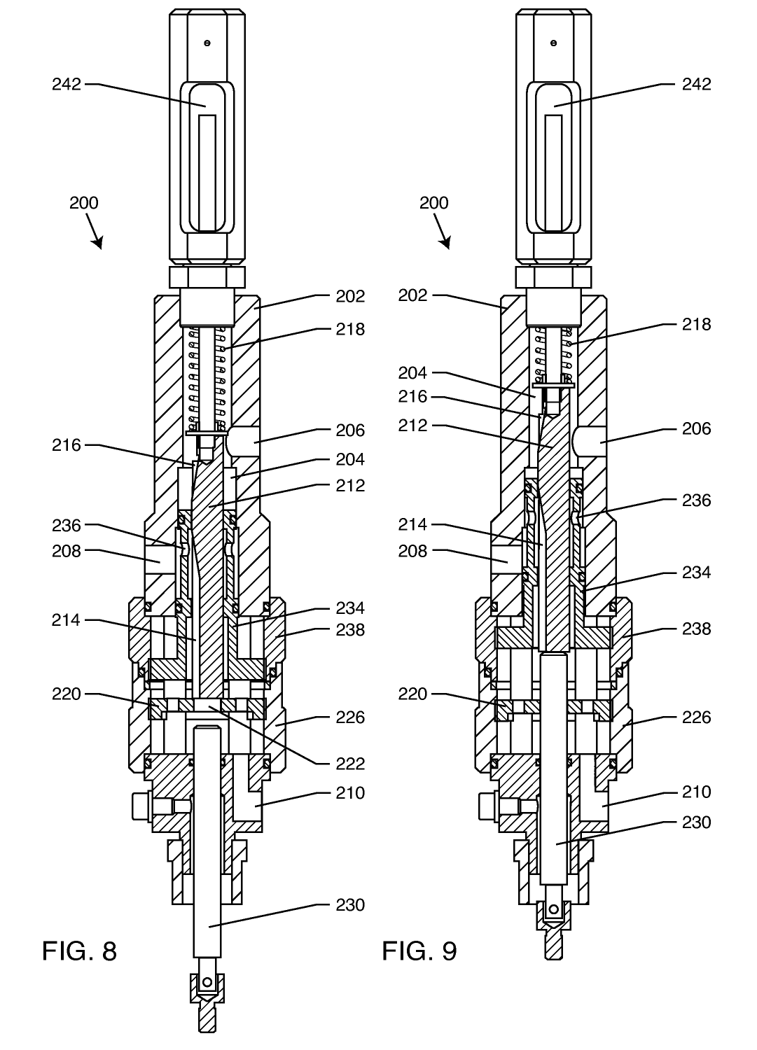

With reference now to FIG. 7, actuator nut 238 is used to adjust position of the sleeve 234, which fixes the slot or passageway of the stem 212 in the unrestricted flow area. As such, the main valve regulates a high pressure. With reference now to FIG. 8, the actuator nut 226 of the stop plate is used to adjust the stop plate 220 to an upper position, which fixes the lower position of the stem 212. This position corresponds to the minimum required low pressure of the system.

With reference now to FIG. 9, the main valve regulates at high pressure. The upper slot or passageway 216 of stem 212 is unrestricted. The sleeve 234 limits the opening of the main valve 100 at the maximum required pressure.

FIGS. 6-9 illustrate that the transition between low pressure and high pressure is a function of the adjust position of the sleeve 234 and the stop plate 222. Moving the stop plate 220 adjusts the length of travel of the valve stem 212, and thus the position of the valve stem 212, particularly when the main valve is in a more closed position. Adjusting the sleeve 234 restricts or unrestricts the fluid flow around and over the slots 214 and 216 of the valve stem 212 between the fluid apertures 206, 208 and 210. Thus, moving the stop plate 220 and the sleeve 234 impacts and adjusts the transition between low and high pressure.

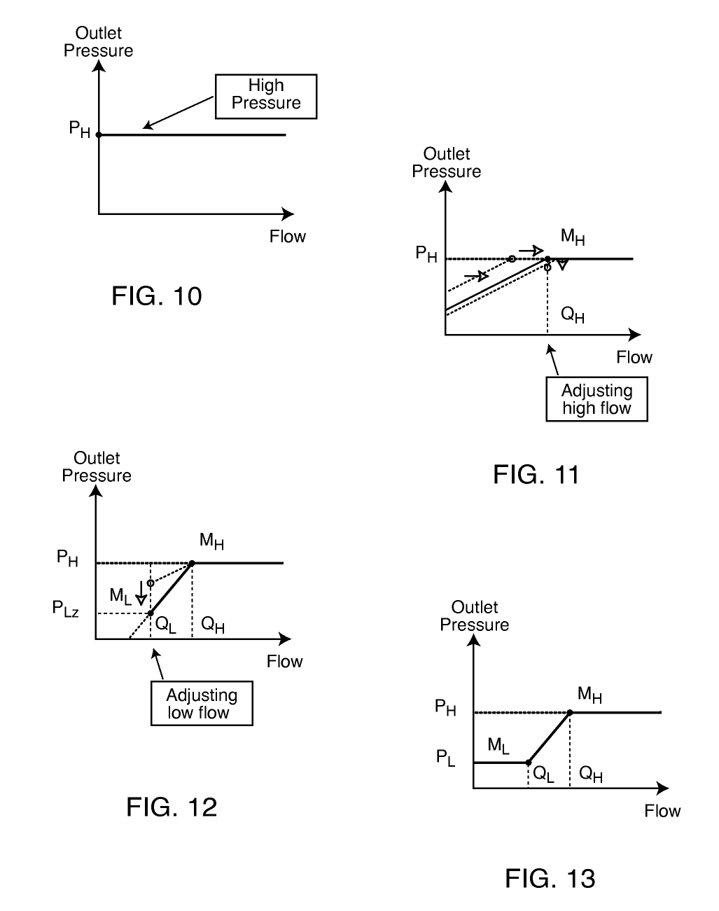

With reference now to FIGS. 10-13, the variable orifice assembly 200 responds to change in flow by adjusting the outlet pressure within user adjusted pressure range and flow range. The outlet pressure will be automatically adjusted between the low flow Q_{L} and high flow Q_{H}. At low flow Q_{L}, the outlet pressure will be P_{L} and at a high flow Q_{H} the outlet pressure will be P_{H}. When system flow is equal or higher than high flow limit, the outlet pressure will be kept at the high pressure setting P_{H}. The same applies when system flow is equal or lower than low flow limit, the outlet pressure will be kept at the low pressure setting P_{H}. At flows between the low flow Q_{L} and high flow Q_{H}, the combination of the variable orifice assembly 200 and the control pilot device 400 and the differential pressure control pilot device 300 allows the outlet pressure to vary in a linear way.

When installing or before doing any adjustment, the manual nuts 238 and 226 of the variable orifice assembly 200 are turned fully anti-clockwise. The air from the variable orifice assembly 200 is drained, such as using screw 244.

The isolation ball valve 42 is closed, and the outlet high pressure PH is adjusted with pressure reducing control pilot device 300 using adjusting screw 318 until the setting is increased to the desired high pressure set point, as illustrated in FIG. 10.

The system flow should be equal to the high flow Q_{H}. The isolation valve 42 is reopened. The control pilot device 400 is adjusted using set screw 422 so that pressure gauge P1 is higher than the valve outlet pressure. The upper nut for the sleeve 238 of the variable orifice assembly 200 adjusts the starting position of the high modulation point M_{H}. The upper nut 230 of the variable orifice assembly is turned clockwise until downstream pressure starts to fall, and then back counterclockwise until high pressure P_{H} adjustment is again reached, as illustrated in FIG. 11.

System flow should be equal to flow Q_{L}. The minimum downstream pressure P_{L} is adjusted using the control pilot device 400. An increase in differential pressure control lowers minimum downstream pressure P_{L}, and in reverse a decrease in differential pressure control pilot device 400 increases minimum downstream pressure P_{L}, as illustrated in FIG. 12.

The lower nut actuator 226 for the stop plate 220 adjusts the starting position of the low modulation point M_{H}. The lower nut 236 is turned clockwise until downstream pressure starts to increase, and then turned back counterclockwise until low pressure P_{L} is again reached, as illustrated in FIG. 13. In this manner, the high pressure set point P_{H} and the low pressure set point P_{L}, and the transition therebetween low flow Q_{L} and high flow Q_{H} is selected. Thus, a desired pressure regulation profile between low and high pressure set points can be selectively achieved.

Although several embodiments have been described in detail for purposes of illustration, various modifications may be made without departing from the scope and spirit of the invention. Accordingly, the invention is not to be limited, except as by the appended claims.

What is claimed is:

1. A system for hydraulically managing fluid pressure in a fluid distribution system between pressure set points, comprising:
a main valve having a fluid inlet and a fluid outlet, the main valve being configured to open to increase fluid flow therethrough and to close to reduce fluid flow therethrough;
a variable orifice assembly coupled to the main valve and having fluid apertures formed in a housing thereof to create a fluid flow pathway therebetween, and a valve stem variably positioned within the housing to alter the fluid flow between the fluid apertures, the valve position and fluid flow being variable as the main valve opens and closes;
at least one control pilot device in fluid communication with the main valve and at least one fluid aperture of the variable orifice assembly, the at least one control pilot device establishing a high pressure set point and a low pressure set point.

2. The system of claim 1, wherein the main valve comprises a main valve body defining the fluid inlet and fluid outlet, a main valve seat disposed between the fluid inlet and the fluid outlet, a main valve member movable between an open position away from the main valve seat and a closed position towards the main valve seat, and a main valve diaphragm coupled to the main valve member, the main valve diaphragm and the main valve body, or a cover thereof, defining a pressure control chamber.

3. The system of claim 2, wherein the at least one control pilot device comprises first and second control devices, each fluidly coupled to a fluid aperture of the variable orifice assembly.

4. The system of claim 3, wherein the first control pilot device is fluidly coupled to the main valve pressure control chamber and directs fluid into the pressure control chamber of the main valve and closes the main valve as fluid flow between fluid apertures of the variable orifice assembly coupled to the first and second control pilot devices is restricted and allows fluid to flow out of the pressure control chamber of the main valve and open the main valve as fluid flow between the fluid apertures of the variable orifice assembly is less restricted.

5. The system of claim 1, wherein the first and second control pilot devices each include a diaphragm disposed between fluid chambers, the position of the diaphragm being variable depending on the pressure differential between the chambers and a bias applied to the diaphragm, the position of the diaphragm varying the fluid flow between an inlet and outlet thereof.

6. The system of claim 1, wherein the variable orifice assembly comprises the housing attachable to the main valve and defining an inner chamber;
first, second and third fluid apertures formed through the housing for coupling the inner chamber to a source of fluid; and
the valve stem disposed within the inner chamber of the housing and movable generally along a length of the inner chamber in response to the main valve opening and closing;
wherein the valve stem has a non-uniform outer configuration creating a fluid pathway thereover; and
wherein fluid flow between the fluid apertures is dependent, in part, on the position of the valve stem within the inner chamber.

7. The system of claim 6, including a sleeve disposed between the valve stem and an inner wall of the housing defining the inner chamber and selectively movable along a length of the inner chamber to vary the fluid flow between the fluid apertures of the housing.

8. The system of claim 6, including a stop plate disposed within the housing between an end of the valve stem and the main valve for limiting travel of the valve stem within the housing, the stop plate being selectively positionable within the housing.

9. The system of claim 8, including a rod extending from the main valve member and movable therewith and extendible through an aperture of the stop plate so as to be engageable with the valve stem.

10. The system of claim 9, wherein the valve stem is biased towards the stop plate and moved away from the stop plate by the rod.

11. The system of claim 6, wherein the valve stem outer configuration forms multiple variable area fluid flow passageways.

12. A variable orifice assembly for hydraulically managing fluid pressure downstream of a main valve of a fluid distribution system between preselected pressure set points, the variable orifice assembly comprising:
a housing attachable to the main valve and defining an inner chamber;
spaced apart fluid apertures formed through the housing for coupling the inner chamber to a source of fluid; and
a valve stem disposed within the inner chamber of the housing and movable generally along a length of the inner chamber in response to the main valve opening and closing;
wherein the valve stem has a non-uniform outer configuration creating a fluid pathway thereover; and
wherein fluid flow between the fluid apertures is dependent, in part, on the position of the valve stem within the inner chamber.

13. The variable orifice assembly of claim 12, wherein the fluid apertures comprise at least three spaced apart fluid flow apertures formed in the housing.

14. The variable orifice assembly of claim 12, including a sleeve disposed between the valve stem and an inner wall of the housing defining the inner chamber.

15. The variable orifice assembly of claim 14, wherein the sleeve is selectively movable along a length of the inner chamber to vary the fluid flow between the fluid apertures of the housing.

16. The variable orifice assembly of claim 15, including an actuator coupled to the housing and the sleeve for selectively moving the sleeve.

17. The variable orifice assembly of claim 16, wherein the actuator comprises a manually rotatable nut.

18. The variable orifice assembly of claim 12, including a stop plate disposed within the housing between an end of the valve stem and the main valve for limiting travel of the valve stem within the housing.

19. The variable orifice assembly of claim 18, wherein the stop plate is selectively movable.

20. The variable orifice assembly of claim 19, including a second actuator coupled to the housing and the stop plate for selectively moving the stop plate.

21. The variable orifice assembly of claim 20, wherein the second actuator comprises a second manually rotatable nut.

22. The variable orifice assembly of claim 19, including a rod extending from the main valve and moving in response to the opening and closing of the main valve and extendible through an aperture of the stop plate so as to engage the variable orifice valve stem.

23. The variable orifice assembly of claim 22, wherein the variable orifice valve stem is biased towards the stop plate and moved away from the stop plate by the rod.

24. The variable orifice assembly of claim 12, wherein the valve stem outer configuration forms multiple variable area fluid flow passageways.
